(19) United States
(12) Patent Application Publication
(10) Pub. No.: US 2022/0131256 A1
(43) Pub. Date: Apr. 28, 2022

(54) ANTENNA DEVICE AND IMAGE DISPLAY DEVICE INCLUDING THE SAME

(71) Applicant: DONGWOO FINE-CHEM CO., LTD., Jeollabuk-do (KR)

(72) Inventors: Young Jun LEE, Seoul (KR); Young Su LEE, Gyeonggi-do (KR); Yoon Ho HUH, Seoul (KR)

(21) Appl. No.: 17/508,029

(22) Filed: Oct. 22, 2021

(30) Foreign Application Priority Data
Oct. 23, 2020 (KR) 10-2020-0138100

(51) Int. Cl. H01Q 1/24; H01Q 1/38; H04M 1/02

(52) U.S. Cl. CPC H01Q 1/243; H04M 1/0266; H01Q 1/38

(57) ABSTRACT

An antenna device according to an exemplary embodiment of the present invention includes a first dielectric layer, a first antenna layer disposed on the first dielectric layer and including a first antenna unit, a second dielectric layer disposed under the first dielectric layer, and a second antenna layer disposed between the first dielectric layer and the second dielectric layer, and including a second antenna unit.

### CROSS-REFERENCE TO RELATED APPLICATION(S) AND CLAIM OF PRIORITY

This application claims the benefit under 35 USC § 119(a) of Korean Patent Application No. 10-2020-0138100, filed on Oct. 23, 2020, in the Korean Intellectual Property Office, the entire disclosure of which is incorporated herein by reference for all purposes.

### BACKGROUND

### 1. Field of the Invention

The present invention relates to an antenna device and an image display device including the same, and more specifically, to an antenna unit including the antenna device and a dielectric layer, and an image display device including the same.

### 2. Description of the Related Art

Recently, according to development of the information-oriented society, wireless communication techniques such as Wi-Fi, Bluetooth, and the like are implemented, for example, in a form of smartphones by combining with image display devices. In this case, an antenna may be coupled to the image display device to perform a communication function.

Recently, with mobile communication techniques becoming more advanced, it is necessary for an antenna for performing communication in a high frequency or ultra-high frequency band corresponding to, for example, 3G, 4G or 5G to be coupled to the image display device.

However, as the image display device on which the antenna is mounted becomes thinner and lighter, a space occupied by the antenna may also be reduced. Accordingly, when a plurality of antennas for signal transmission/reception in a high frequency or ultra-high frequency band are included in the image display device, radiation performance may be deteriorated.

Therefore, it is necessary to develop an antenna capable of preventing a deterioration in radiation performance while implementing signal transmission/reception in a high frequency or ultra-high frequency band through an antenna device occupying a small space. For example, Korean Patent Laid-Open Publication No. 2003-0095557 discloses an antenna structure embedded in a portable terminal, but the antenna structure cannot sufficiently implement the above-described recent requirements for the antenna.

### SUMMARY

An object of the present invention is to provide an antenna device having improved radiation characteristics and space efficiency.

Another object of the present invention is to provide an image display device including the antenna device having improved radiation characteristics and space efficiency.

To achieve the above objects, the following technical solutions are adopted in the present invention.

1. Antenna device including: a first dielectric layer; a first antenna layer disposed on an upper surface of the first dielectric layer and including a first radiator; and a second antenna layer disposed on a lower surface of the first dielectric layer and including a second radiator which is overlapped with the first radiator in a thickness direction and has a resonance frequency lower than that of the first radiator.

2. The antenna device according to the above 1, wherein the second antenna layer is provided as a ground layer for the first radiator.

3. The antenna device according to the above 1, wherein the second radiator has a larger length or area than that of the first radiator.

4. The antenna device according to the above 3, wherein the first radiator is included in the second radiator when projected in a planar direction.

5. The antenna device according to the above 1, wherein the second antenna layer further comprises a second transmission line extending from the second radiator, and a second signal pad formed at one end of the second transmission line.

6. The antenna device according to the above 5, wherein the second antenna layer further comprises second ground pads which are disposed around the second signal pad and the second transmission line, and are disposed with being separated from the second signal pad and the second transmission line on the same layer.

7. The antenna device according to the above 6, wherein the second ground pad is provided as a ground layer for the second radiator.

8. The antenna device according to the above 6, wherein the second ground pad has a greater length than that of the second signal pad so as to be adjacent to the second radiator.

9. The antenna device according to the above 1, wherein a resonance frequency of the first radiator is 20 GHz or more, and a resonance frequency of the second radiator is 10 GHz or less.

10. The antenna device according to the above 1, wherein the first radiator includes a mesh structure.

11. The antenna device according to the above 1, wherein the second radiator includes a mesh structure including electrode lines which intersect each other, and each of the electrode lines has a line width of 2.5 to 25 μm.

12. The antenna device according to the above 1 further comprising a first circuit board electrically connected to the first antenna layer and a second circuit board electrically connected to the second antenna layer.

13. The antenna device according to the above 12, wherein the first circuit board and the second circuit board are disposed on different sides among peripheral portions of the first dielectric layer.

14. An image display device including the above-described antenna device.

According to embodiments of the present invention, the second antenna layer may be formed under the first antenna layer to be provided as a ground layer. Accordingly, it is possible to implement signal transmission/reception in a high frequency or ultra-high frequency band without a separate ground layer, and it is possible to transmit/receive signals in a plurality of bands in one antenna device.

According to some embodiments, the first radiator included in the first antenna layer may have a resonance frequency of 20 GHz or more, and the second radiator included in the second antenna layer may have a resonance frequency of 10 GHz or less. Accordingly, it is possible to implement signal transmission/reception in a high frequency or ultra-high frequency band of 3G, 4G, 5G or higher, and signal transmission/reception in low frequency band such as Wi-Fi, Sub-6, and Zigbee together in one antenna device.

The antenna device may be applied to a display device including a mobile communication device capable of signal transmitting/receiving in a high frequency or ultra-high frequency band of 3G, 4G, 5G or higher, or a glass window including glass to improve optical properties such as radiation characteristics and transmittance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating an antenna device according to exemplary embodiments;

FIG. 2 is a schematic plan view illustrating an antenna device according to exemplary embodiments;

FIG. 3 is a schematic plan view illustrating an antenna device according to exemplary embodiments;

FIG. 4 is a schematic plan view illustrating an antenna device according to exemplary embodiments;

FIGS. 5 and 6 are schematic cross-sectional views illustrating antenna devices according to exemplary embodiments; and

FIG. 7 is a plan view illustrating an image display device according to exemplary embodiments.

### DETAILED DESCRIPTION OF THE INVENTION

Embodiments of the present invention provide an antenna device capable of resonating or radiating radio waves in a plurality of frequency bands. According to exemplary embodiments, the antenna device may be provided as a dual band resonance antenna.

The antenna device may include, for example, a microstrip patch antenna, a monopole antenna, or a dipole antenna, which are manufactured in the form of a transparent film. The antenna device may be applied to a communication device for high frequency or ultra-high frequency (e.g., 3G, 4G, 5G or higher) communication and low frequency communication (Wi-Fi, Sub-6, Zigbee), for example.

However, in relation to an application of the antenna device, the use of the antenna device is not limited to the display device, and the antenna device may be applied to various structures such as a vehicle, a home appliance, a building, a glass window and the like.

Further, embodiments of the present invention provide an image display device including the antenna device.

Hereinafter, preferred embodiments of the present invention will be described in detail with reference to the accompanying drawings. However, since the drawings attached to the present disclosure are only given for illustrating one of preferable various embodiments of present invention to easily understand the technical spirit of the present invention with the above-described invention, it should not be construed as limited to such a description illustrated in the drawings.

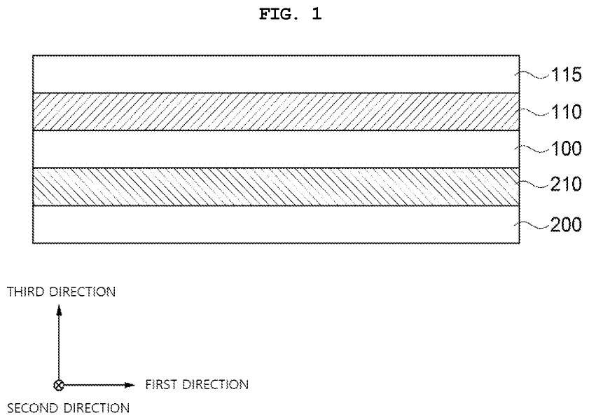

FIG. 1 is a schematic cross-sectional view illustrating an antenna device according to exemplary embodiments.

In FIG. 1, two directions, which are parallel to an upper surface of a first dielectric layer 100 and intersect each other, are defined as a first direction and a second direction, respectively. For example, the first direction and the second direction may intersect each other perpendicularly. A direction perpendicular to the upper surface of the first dielectric layer 100 is defined as a third direction. For example, the first direction may correspond to a length direction of the antenna device, the second direction may correspond to a width direction of the antenna device, and the third direction may correspond to a thickness direction of the antenna device. The definition of the directions may also be equally applied in all the drawings.

Referring to FIG. 1, the antenna device may include the first dielectric layer 100, a first antenna layer 110 disposed on the first dielectric layer 100, a second dielectric layer 200 disposed below the first dielectric layer 100, and a second antenna layer 210 disposed between the first dielectric layer 100 and the second dielectric layer 200.

The first and second dielectric layers 100 and 200 may include an insulation material having a predetermined dielectric constant. For example, these layers may include a foldable transparent resin material having flexibility.

For example, the first and second dielectric layers 100 and 200 may include a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acrylic resin such as polymethyl (meth)acrylate, polyethyl (meth)acrylate, etc.; a styrene resin such as polystyrene, acrylonitrile-styrene copolymer, etc.; a polyolefin resin such as polyethylene, polypropylene, cyclic polyolefin or polyolefin having a norbornene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; an epoxy resin; a urethane or acrylic urethane resin, a silicone resin and the like. These may be used alone or in combination of two or more thereof.

In some embodiments, the first and second dielectric layers 100 and 200 may include an adhesive material such as an optically clear adhesive (OCA), an optically clear resin (OCR) and the like.

In some embodiments, the first and second dielectric layers 100 and 200 may include an inorganic insulation material such as glass, silicon oxide, silicon nitride, silicon oxynitride or the like.

In some embodiments, the first and second dielectric layers 100 and 200 may have a dielectric constant adjusted in a range of about 1.5 to 12. When the dielectric constant exceeds about 12, signal loss of transmission lines 124 and 224, which will be described below, is excessively increased, such that signal sensitivity and signal efficiency during high frequency band communication may be decreased.

In some embodiments, the antenna device may further include a third dielectric layer 115 disposed on the first antenna layer 110. For example, the third dielectric layer 115 may include substantially the same adhesive film, transparent resin material, and/or inorganic insulation material as the first and second dielectric layers 100 and 200.

In some embodiments, the third dielectric layer 115 may be a cover window. The cover window may include, for example, glass (such as ultra-thin glass (UTG)) or a transparent resin film.

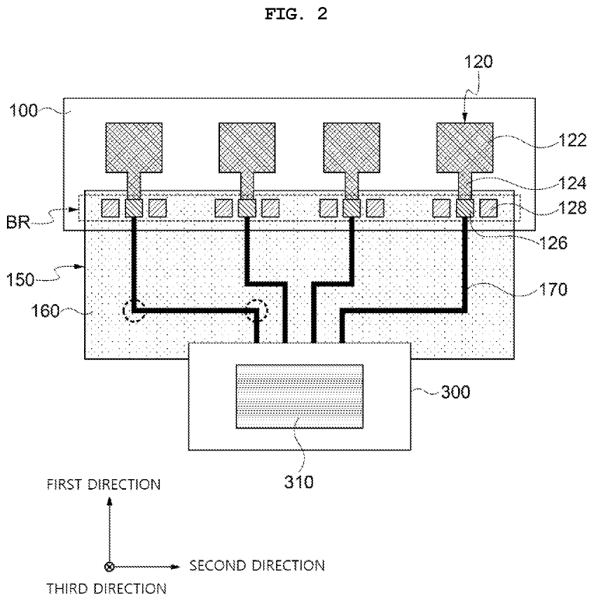

FIG. 2 is a schematic plan view illustrating an antenna device according to exemplary embodiments.

Referring to FIG. 2, in exemplary embodiments, the first antenna layer 110 may include a first antenna unit 120 disposed on the first dielectric layer 100.

The first antenna unit 120 may include a first radiator 122 and a first transmission line 124. The first radiator 122 may have, for example, a polygonal plate shape, and the first transmission line 124 may extend from one side of the first radiator 122. The first transmission line 124 may be integrally foamed with the first radiator 122 as a substantial single member.

According to exemplary embodiments, the first radiator 122 may provide signal transmission/reception in a high frequency or ultra-high frequency (e.g., 3G, 4G, 5G or higher) band. In some embodiments, a resonance frequency of the first antenna unit 120 may be 20 GHz or more. As a non-limiting example, the resonance frequency of the first antenna unit 120 may be about 24 to 29.5 GHz, and/or about 37 to 45 GHz.

In exemplary embodiments, the first radiator 122 may control the resonance frequency capable of driving the antenna by adjusting an area of the radiator.

In some embodiments, the first antenna unit 120 may further include a first signal pad 126. The first signal pad 126 may be connected to one end of the first transmission line 124.

In some embodiments, the first signal pad 126 may be provided as an integral member with the first transmission line 124, and a distal end of the first transmission line 124 may also be provided as the first signal pad 126.

According to some embodiments, first ground pads 128 may be disposed around the first signal pad 126. For example, a pair of first ground pads 128 may be disposed to face each other with the first signal pad 126 interposed therebetween. The first ground pad 128 may be electrically and physically separated from the first transmission line 124 and the first signal pad 126. Accordingly, noise generated when transmitting/receiving a radiation signal through the first signal pad 126 may be efficiently filtered or reduced.

For example, the first ground pad 128 may also be provided as a ground layer for the first radiator 122, and vertical radiation may be implemented through the first radiator 122. In some embodiments, a separate ground layer may be formed under the first radiator 122 and a second radiator 222 to be described below, and a conductive member of the display device on which the antenna device is mounted may be provided as a ground layer for the radiation bodies 122 and 222. The conductive member may include, for example, a gate electrode of a thin film transistor (TFT) included in the display panel, various wirings such as scan lines or data lines, or various electrodes such as pixel electrodes, common electrodes and the like.

In one embodiment, for example, various structures including a conductive material disposed under the display panel may be provided as the ground layer. For example, a metal plate (such as a stainless steel (SUS) plate), a pressure sensor, a fingerprint sensor, an electromagnetic wave shielding layer, a heat radiation sheet, a digitizer, etc. may be provided as the ground layer.

In exemplary embodiments, the antenna units 120 and 220 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), molybdenum (Mo), tin (Sn), calcium (Ca), or an alloy including at least one thereof. These may be used alone or in combination of two or more thereof.

For example, the antenna units 120 and 220 may include silver (Ag) or a silver alloy, for example, a silver-palladium-copper (APC) alloy to implement a low resistance. In some embodiments, the antenna units 120 and 220 may include copper (Cu) or a copper alloy (e.g., a copper-calcium (CuCa) alloy) in consideration of low resistance and fine line width patterning. In some embodiments, antenna units 120 and 220 may include a transparent conductive oxide such as indium tin oxide (ITO), indium zinc oxide (IZO), indium zinc tin oxide (IZTO), or zinc oxide (ZnOx).

In some embodiments, the antenna units 120 and 220 may include a lamination structure of a transparent conductive oxide layer and metal layer, for example, may have a two-layer structure of transparent conductive oxide layer-metal layer or a three-layer structure of transparent conductive oxide layer-metal layer-transparent conductive oxide layer. In this case, resistance may be reduced to improve signal transmission speed while improving flexible properties by the metal layer, and corrosion resistance and transparency may be improved by the transparent conductive oxide layer.

The antenna units 120 and 220 may include a blackening processing part, respectively. Accordingly, reflectance on surfaces of the antenna units 120 and 220 may be decreased, thereby reducing the pattern from being viewed due to light reflection.

In one embodiment, the surface of the metal layer included in the antenna units 120 and 220 may be converted into metal oxide or metal sulfide to form a blackened layer. In one embodiment, the blackened layer such as a black material coating layer or a plating layer may be foamed on the antenna units 120 and 220 or the metal layer. Herein, the black material coating layer or plating layer may include silicon, carbon, copper, molybdenum, tin, chromium, nickel, cobalt, or oxide, sulfide, or an alloy containing at least one of them.

The composition and thickness of the blackened layer may be adjusted in consideration of an effect of reducing reflectance.

In some embodiments, the first radiator 122 and the first transmission line 124 may include a mesh-pattern structure for improving transmittance. In this case, a dummy mesh electrode (not illustrated) may be formed around the first radiator 122 and the first transmission line 124.

The first signal pad 126 and the first ground pad 128 may be foamed in a solid structure made of the above-described metals or alloy in consideration of a reduction in power supply resistance, noise absorption efficiency, and improvement in horizontal radiation characteristics.

In some embodiments, the first radiator 122 may have a mesh-pattern structure, and the first transmission line 124, the first signal pad 126 and the first ground pad 128 may be foamed in a solid metal pattern.

In this case, the first radiator 122 may be disposed in a display region of an image display device to be described below, and the first transmission line 124, the first signal pad 126 and the first ground pad 128 may be disposed in a non-display region or a bezel region of the image display device.

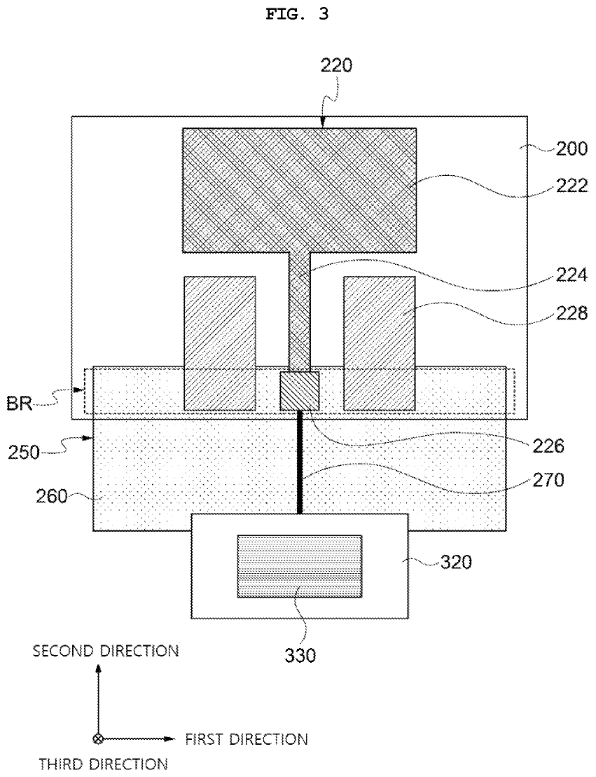

FIG. 3 is a schematic plan view illustrating an antenna device according to exemplary embodiments. Specifically, FIG. 3 is a schematic plan view of the second antenna layer 210 according to exemplary embodiments.

Referring to FIG. 3, in exemplary embodiments, the second antenna layer 210 may include a second antenna unit 220 disposed on the second dielectric layer 200.

The second antenna unit 220 may include the second radiator 222 and a second transmission line 224. The second radiator 222 may have, for example, a polygonal plate shape, and the second transmission line 224 may extend from one side of the second radiator 222. The second transmission line 224 may be integrally foamed with the second radiator 222 as a substantial single member.

The second antenna layer 210 may be provided as a ground layer for the first radiator 122. For example, the second radiator 222 may be overlapped with the first radiator 122 in the thickness direction.

In this case, the first radiator 122 having a resonance frequency of a high frequency or ultra-high frequency band may not include a separate ground layer. Thereby, a thickness of the antenna device may be reduced to increase space efficiency, and signals of a plurality of bands may be transmitted/received by one antenna device.

In exemplary embodiments, the second radiator 222 may have a smaller resonance frequency than that of the first radiator 122.

According to some embodiments, the second radiator 222 may provide signal transmission/reception in a low frequency band (such as Wi-Fi, Sub-6, Zigbee). For example, the resonance frequency of the second antenna unit 220 may be 10 GHz or less. The Wi-Fi and ZigBee may mean a transmission/reception channel of a 2.4 GHz band, and Sub-6 may mean a transmission/reception channel of a 3 to 6 GHz band.

In some embodiments, the resonance frequency of the first antenna unit 120 may be 20 GHz or more, and the resonance frequency of the second antenna unit 220 may be 10 GHz or less. In this case, it is possible to implement signal transmission/reception in a high frequency or ultra-high frequency band and signal transmission/reception in a low frequency band such as Wi-Fi, Sub-6 and/or Zigbee together in one antenna device. Thereby, it is possible to implement signal transmission/reception in high frequency or ultra-high frequency and low frequency bands together in one antenna device, and space efficiency may be increased since a separate ground layer is not required.

In some embodiments, the second radiator 222 may control the resonance frequency capable of driving the antenna by adjusting the area of each radiator.

For example, the second radiator 222 may have a greater length or area than that of the first radiator 122. Accordingly, the second radiator 222 may have a smaller resonance frequency than that of the first radiator 122.

In some embodiments, the second antenna unit 220 may further include a second signal pad 226. The second signal pad 226 may be connected to one end of the second transmission line 224.

In some embodiments, the second signal pad 226 may be provided as an integral member with the second transmission line 224, and a distal end of the second transmission line 224 may also be provided as the second signal pad 226.

In exemplary embodiments, the second antenna unit 220 may include a coplanar waveguide (CPW) line structure.

For example, second ground pads 228 may be disposed around the second transmission line 224 and the second signal pad 226 with being separated from the second transmission line 224 and the second signal pad 226 on the same layer. For example, a pair of second ground pads 228 may be disposed to face each other with being spaced apart from each other with the second transmission line 224 and the second signal pad 226 interposed therebetween. The second ground pads 228 may be electrically and physically separated from the second transmission line 224 and the second signal pad 226. Accordingly, noise generated in the processes of transmitting/receiving a radiation signal through the second signal pad 226 and transmitting an electrical signal through the second transmission line 224 may be efficiently filtered or reduced.

In some embodiments, the second ground pad 228 may be provided as a ground layer for the second radiator 222. In this case, the second radiator 222 and the second ground pad 228 may be located on the same layer or on the same level. Accordingly, since a separate ground layer may not be included in the antenna device, the thickness of the antenna device can be reduced and space efficiency can be increased.

In some embodiments, the second ground pad 228 may have a greater length than that of the second signal pad 226 so as to be adjacent to the second radiator 222. Accordingly, effects of reducing noise and forming an electric field of the second ground pad 228 may be sufficiently implemented.

In exemplary embodiments, the second antenna unit 220 may include substantially the same metal or alloy as the first antenna unit 120.

In some embodiments, the second radiator 222 and the second transmission line 224 may have a solid structure made of the above-described metals or alloy in consideration of reduction in power supply resistance, noise absorption efficiency and radiation characteristics.

In some embodiments, the second radiator 222 and the second transmission line 224 may have a mesh structure including electrode lines which intersect each other in consideration of external visibility.

In this case, a line width of the electrode lines included in the second radiator 222 and the second transmission line 224 may be 2.5 to 25 μm.

For example, when the line width of the electrode lines is less than 2.5 μm, a function of the second antenna layer 210 as a ground layer for the first radiator 122 may not be sufficiently implemented, and thereby, the antenna gain of the first antenna unit 120 may be decreased, and vertical radiation properties may not be sufficiently implemented.

For example, when the line width of the electrode lines exceeds 25 μm, the line width may be excessively increased to cause a problem in which the electrode lines are easily viewed from an outside.

Accordingly, in the above line width range, for example, it is possible to sufficiently implement signal transmission/reception and excellent radiation characteristics in a high frequency or ultra-high frequency band and a low frequency band, while maintaining the radiation performance of the first antenna unit 120.

The second signal pad 226 and the second ground pad 228 may be formed in a solid pattern made of the above-described metals or alloy in consideration of a reduction in power supply resistance, noise absorption efficiency, and improvement in horizontal radiation characteristics.

As shown in FIGS. 2 and 3, in some embodiments, the antenna device may further include a first circuit board 150 electrically connected with the first antenna unit 120 and a second circuit board 250 electrically connected with the second antenna unit 220.

The first circuit board 150 may include a first core layer 160 and first signal wirings 170 which are formed and extend on the surface of the first core layer 160, and the second circuit board 250 may include a second core layer 260 and a second signal wiring 270 which are formed and extend on the surface of the second core layer 260. For example, the first circuit board 150 and the second circuit board 250 may be a flexible printed circuit board (FPCB), respectively.

The first core layer 160 and the second core layer 260 may include, for example, flexible resins such as a polyimide resin, modified polyimide (MPI), epoxy resin, polyester, cyclic olefin polymer (COP), liquid crystal polymer (LCP) and the like. The first core layer 160 and the second core layer 260 may include internal insulation layers included in the first circuit board 150 and the second circuit board 250, respectively.

The first signal wirings 170 and the second signal wiring 270 may be provided, for example, as power supply lines. For example, the first signal wirings 170 may be arranged on one surface (e.g., a surface facing the first antenna unit 120) of the first core layer 160, and the second signal wiring 270 may be arranged on one surface (e.g., a surface facing the second antenna unit 220) of the second core layer 260.

For example, the first circuit board 150 and the second circuit board 250 may further include a first coverlay film and a second coverlay film, which are formed on the one surface of each of the first core layer 160 and the second core layer 260 to cover the first signal wirings 170 and the second signal wiring 270.

The first signal wirings 170 and the second signal wiring 270 may be connected or bonded to the first signal pad 126 of the first antenna unit 120 and the second signal pad 226 of the second antenna unit 220, respectively. For example, the first coverlay film of the first circuit board 150 and the second coverlay film of the second circuit board 250 may be partially removed to expose one end of each of the first signal wirings 170 and the second signal wiring 270. The exposed ends of the first signal wirings 170 and the second signal wiring 270 may be adhered to the first signal pad 126 and the second signal pad 226, respectively.

For example, a first conductive adhesive structure 130 such as an anisotropic conductive film (ACF) is attached to the first signal pad 126, and then a bonding region BR may be disposed on the conductive adhesive structure of the first circuit board 150 on which the one end of each of the first signal wirings 170 are located. Thereafter, the bonding region BR of the first circuit board 150 may be attached to the first antenna unit 120 through a heat treatment/pressing process, and the first signal wirings 170 may be electrically connected to the first signal pad 126.

For example, after attaching the second conductive adhesive structure 230 such as an anisotropic conductive film (ACF) on the second signal pad 226, the bonding region BR of the second circuit board 250 on which the one end of the second signal wiring 270 is located may be disposed on the conductive adhesive structure. Thereafter, the bonding region BR of the second circuit board 250 may be attached to the second antenna unit 220 through a heat treatment/pressing process, and the second signal wiring 270 may be electrically connected to the second signal pad 226.

In addition, as the first ground pads 128 and the second ground pads 228 are arranged around the first signal pad 126 and the second signal pad 226, respectively, adhesion to the anisotropic conductive film (ACF) may be increased, thus to improve bonding stability.

As illustrated in FIG. 2, the first signal wirings 170 may be each independently connected or bonded to each of the first signal pads 126 of the first antenna unit 120. In this case, power supply and control signals may be independently supplied from a first antenna driving integrated circuit (IC) chip 310 to the first antenna unit 120.

In some embodiments, a predetermined number of first antenna units 120 may be coupled with each other through the first signal wirings 170.

In some embodiments, the first circuit board 150 and the second circuit board 250 may be integrally formed with the first dielectric layer 100 and the second dielectric layer 200, respectively. For example, the first core layer 160 and the second core layer 260 may be formed integrally with the first dielectric layer 100 and the second dielectric layer 200 using substantially the same member, respectively. Accordingly, a separate heating and pressing process such as bonding or attaching is unnecessary, such that signal loss and mechanical damage in the antenna units 120 and 220 that may be caused by the heating and pressing process can be prevented.

The circuit boards 150 and 250 or the core layers 160 and 260 may have a variable width. According to exemplary embodiments, the first circuit board 150 or the first core layer 160 may include a first antenna connection part and a first wiring extension part having different widths from each other, and the second circuit board 250 or the second core layer 260 may include a second antenna connection part and a second wiring extension part having different widths from each other.

One end portion of each of the first and second antenna connection parts may include a bonding region BR, and may be bonded to the pads 126, 128, 226 and 228 of the antenna units 120 and 220 through the bonding regions (BRs).

The first signal wirings 170 and the second signal wiring 270 may extend from one end portion of each of the first circuit board 150 and the second circuit board 250 including the bonding regions (BRs) toward the other end portion thereof, respectively. For example, each of the first signal wirings 170 may include bent portions (see dotted line circles in FIG. 2) on the first antenna connection part to enter the first wiring extension part.

According to exemplary embodiments, the first and second wiring extension parts may have a smaller width than that of the first and second antenna connection parts, respectively. As described above, the first signal wirings 170 may extend with a relatively narrow interval on the first wiring extension part through the bent portions.

The first antenna driving IC chip 310 is mounted on the first wiring extension part or the other end portion of the first circuit board 150 to be electrically connected with the first signal wirings 170, and a second antenna driving integrated circuit (IC) chip 330 may be mounted on the second wiring extension part or the other end portion of the second circuit board 250 to be electrically connected with the second signal wiring 270. Accordingly, the power supply and driving signals may be applied to the first antenna unit 120 via the first signal wiring 170 by the first antenna driving IC chip 310, and the power supply and driving signals may be applied to the second antenna unit 220 via the second signal wiring 270 by the second antenna driving IC chip 330.

In some embodiments, a first relay circuit board 300 may be disposed on the other end portion of the first wiring extension part, and the first antenna driving IC chip 310 may be mounted on the first relay circuit board 300 using a surface mount technology (SMT), for example.

In some embodiments, a second relay circuit board 320 may be disposed on the other end portion of the second wiring extension part, and the second antenna driving IC chip 330 may be mounted on the second relay circuit board 320 using the surface mount technology (SMT), for example.

In some embodiments, the first and second antenna driving IC chips 310 and 330 may be mounted together on one relay circuit board. In this case, supply power and driving signals can be applied to the first and second antenna units 120 and 220 from one relay circuit board, such that the space efficiency of an image display device to be described below may be increased.

The term “relay circuit board” as used herein may collectively refer to a circuit structure or a circuit board positioned between the circuit boards 150 and 250 and the antenna driving IC chips 310 and 330.

For example, the first and second relay circuit boards 300 and 320 may include a main board, a rigid printed circuit board, and various antenna device boards of the image display device.

When the first relay circuit board 300 and the second relay circuit board 320 are provided as the rigid printed circuit boards, for example, the first relay circuit board 300 and the second relay circuit board 320 may have a higher strength or a lower ductility than that of the first circuit board 150 and the second circuit board 250, respectively. Accordingly, mounting stability of the first antenna driving IC chip 310 and the second antenna driving IC chip 330 may be improved. For example, when the first and second relay circuit boards 300 and 320 are provided as the rigid printed circuit boards, these boards may include a core layer formed of a resin (e.g., prepreg) impregnated with an inorganic material such as glass fiber and relay circuits formed in the core layer.

As described above, the first and second circuit boards 150 and 250 may include a plurality of portions having different widths from each other. According to exemplary embodiments, sufficient bonding stability with the first antenna unit 120 and the second antenna unit 220 may be secured through the first antenna connection part and the second antenna connection part having a relatively wide width, respectively. In addition, a sufficient interval between the first signal wirings 170 may be secured in the first antenna connection part to enhance independence of the power supply/signal applied to each first antenna unit 120.

Further, flexibility and circuit connection characteristics of the antenna device may be improved through the first and second wiring extension parts having a relatively small width. For example, the first and second antenna driving IC chips 310 and 330 may be disposed on a rear portion of the image display device to be described below, and the first and second antenna units 120 and 220 may be disposed on a front portion of the image display device.

In this case, circuit connection with the first and second antenna driving IC chips 310 and 330 may be easily implemented by bending the first and second wiring extension parts to the rear portion side of the image display device. In addition, it is possible to prevent the first and second signal wirings 170 and 270 from being mechanically damaged by stress propagation due to excessively increased bending area, and thereby, low resistance power supply and signal application may be implemented with high reliability.

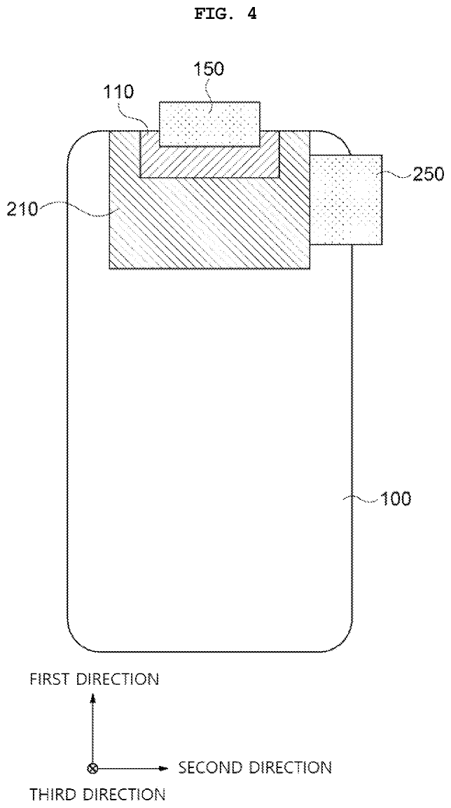

FIG. 4 is a schematic plan view illustrating an antenna device according to exemplary embodiments. Specifically, FIG. 4 is a schematic plan view illustrating an antenna device in which the first antenna layer 110 and the second antenna layer 210 are overlapped with each other in a planar direction in some embodiments. The first antenna unit 120, the second antenna unit 220, and the signal wirings 170 and 270 are not illustrated for the convenience of description.

Referring to FIG. 4, as described above in exemplary embodiments, the second antenna layer 210 may be provided as a ground layer for the first radiator 122, and the second antenna layer 210 and/or the second radiator 222 may have a greater length or area than that of the first radiator 122. In this case, the second radiator 222 may have a lower resonance frequency than that of the first radiator 122. Accordingly, one antenna device which does not include a separate ground layer formed therein may transmit/receive signals of high frequency or ultra-high frequency and low frequency bands together.

In some embodiments, the first radiator 122 may be included in the second radiator 222 when projected in the planar direction.

In some embodiments, the first circuit board 150 and the second circuit board 250 may be disposed on different sides among peripheral portions of the first dielectric layer 100.

For example, the first circuit board 150 may be disposed on one side among the peripheral portions of the first dielectric layer 100 in a first direction, which is a width direction, to be electrically connected with the first antenna unit 120, and the second circuit board 250 may be disposed on one side among the peripheral portions of the first dielectric layer 100 in a second direction, which is a longitudinal direction, to be electrically connected with the second antenna unit 220.

Accordingly, directions, in which the first circuit board 150 and the second circuit board 250 extend, are not overlapped with each other, such that the space efficiency of the image display device to be described below and the antenna device may be increased.

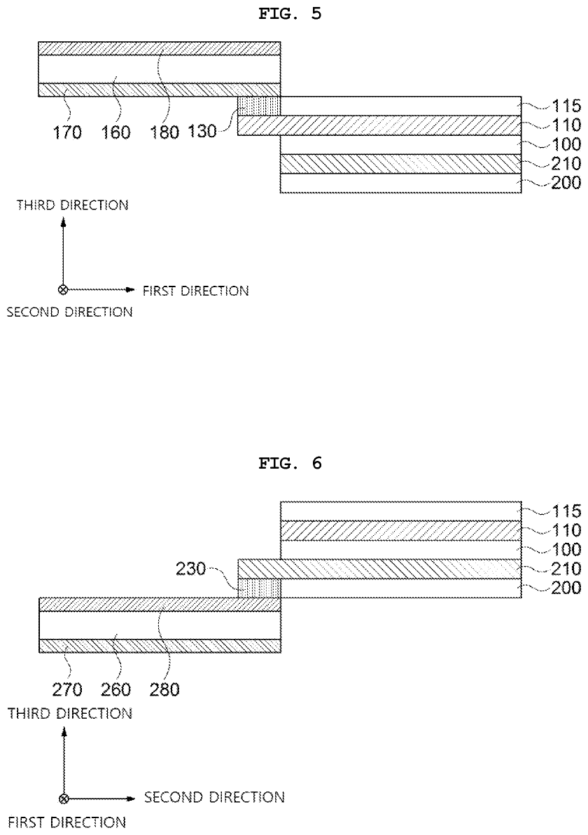

FIGS. 5 and 6 are schematic cross-sectional views illustrating antenna devices according to exemplary embodiments.

Referring to FIGS. 5 and 6, the first ground layer 180 and the second ground layer 280 may be respectively disposed on one surface of each of the first core layer 160 and the second core layer 260. The first ground layer 180 may be commonly overlapped with the first signal wirings 170 in the planar direction, and the second ground layer 280 may be commonly overlapped with the second signal wiring 270 in the planar direction. Thus, noise and signal interference around the first signal wirings 170 and the second signal wiring 270 may be absorbed or shielded through the first ground layer 180 and the second ground layer 280. In addition, generation of an electric field from each of the first signal wirings 170 and the second signal wiring 270 may be promoted by the first ground layer 180 and the second ground layer 280, such that signal transmission efficiency may be improved.

The widths of the first and second wiring extension parts may be reduced as described above, but the interval between the first signal wirings 170 may be maintained in order to ensure sufficient generation of the electric field through the first ground layer 180. In some embodiments, the interval between the first signal wirings 170 adjacent to each other on the first wiring extension part may be three times or more of a line width of each first signal wiring 170.

The above-described signal wirings 170 and 270, and the ground layers 180 and 280 may include the above-described metals and/or alloy.

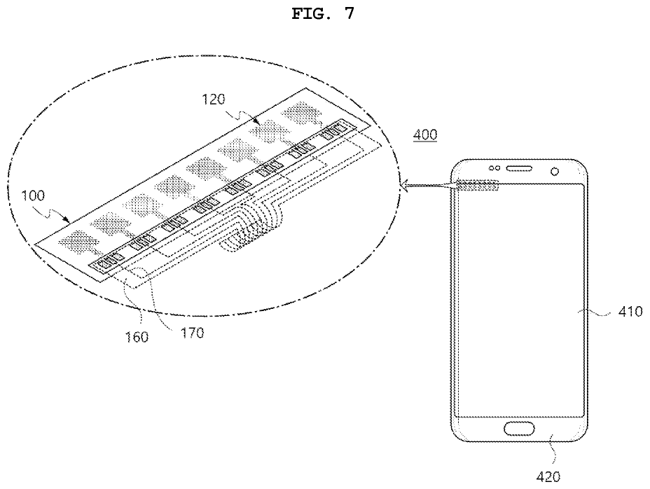

FIG. 7 is a plan view illustrating an image display device according to exemplary embodiments. In FIG. 7, the second antenna unit 220, the second signal wiring 270, and the second circuit board 250 are located as shown in FIGS. 1 to 6, but are not illustrated for the convenience of description.

Referring to FIG. 7, an image display device 400 may be implemented in a form of, for example, a smart phone. FIG. 7 shows the front portion or window surface of the image display device 400. The front portion of the image display device 400 may include a display region 410 and a peripheral region 420. The peripheral region 420 may correspond to, for example, a light-shielding part or a bezel part of the image display device 400.

The antenna units 120 and 220 included in the above-described antenna device may be disposed toward the front portion of the image display device 400, and may be disposed on a display panel, for example. In one embodiment, the radiation bodies 122 and 222 may be at least partially overlapped with the display region 410.

In this case, the first and second radiation bodies 122 and 222 may include a mesh-pattern structure, and a decrease in transmittance due to the first and second radiation bodies 122 and 222 may be prevented. The first and second antenna driving IC chips 310 and 330 included in the antenna device may be disposed in the peripheral region 420 to prevent a deterioration of image quality in the display region 410.

In some embodiments, the antenna device is bent through the first and second circuit boards 150 and 250, such that the first and second antenna driving IC chips 310 and 330 may be disposed on the rear portion of the image display device 400, for example.

In some embodiments, the above-described antenna device may be coupled to glass, and may be implemented in the form of a glass window, for example. The first antenna layer 110 may be formed on one surface of the glass window, and the second antenna layer 210 may be foamed on the other surface of the glass window.

For example, the first antenna unit 120 that can implement signal transmission/reception in a high frequency or ultra-high frequency band may be disposed on an outer surface of the glass window in contact with an outside of the building or home appliance, and the second antenna unit 220 that can implement signal transmission/reception in a low frequency band may be disposed on an inner surface of the glass window in contact with an inside of the building or home appliance. In this case, the first and second antenna units 120 and 220 may include a mesh structure to reduce visibility, and the electrode lines included in the second antenna unit 220 may have a line width of 2.5 to 25 μm.

As described above, the second antenna layer 210 including the second antenna unit 220 that can implement signal transmission/reception in a low frequency band is provided as a ground layer for the first antenna unit 120, such that excellent space efficiency may be implemented by reducing the thickness of the antenna device, while simultaneously implementing signal transmission/reception in a high frequency or ultra-high frequency band and a low frequency band.

What is claimed is:

1. Antenna device comprising:
a first dielectric layer;
a first antenna layer disposed on an upper surface of the first dielectric layer and including a first radiator; and
a second antenna layer disposed on a lower surface of the first dielectric layer and including a second radiator which is overlapped with the first radiator in a thickness direction and has a resonance frequency lower than that of the first radiator.

2. The antenna device according to claim 1, wherein the second antenna layer is provided as a ground layer for the first radiator.

3. The antenna device according to claim 1, wherein the second radiator has a larger length or area than that of the first radiator.

4. The antenna device according to claim 3, wherein the first radiator is included in the second radiator when projected in a planar direction.

5. The antenna device according to claim 1, wherein the second antenna layer further comprises a second transmission line extending from the second radiator, and a second signal pad formed at one end of the second transmission line.

6. The antenna device according to claim 5, wherein the second antenna layer further comprises second ground pads which are disposed around the second signal pad and the second transmission line, and are disposed with being separated from the second signal pad and the second transmission line on the same layer.

7. The antenna device according to claim 6, wherein the second ground pad is provided as a ground layer for the second radiator.

8. The antenna device according to claim 6, wherein the second ground pad has a greater length than that of the second signal pad so as to be adjacent to the second radiator.

9. The antenna device according to claim 1, wherein a resonance frequency of the first radiator is 20 GHz or more, and a resonance frequency of the second radiator is 10 GHz or less.

10. The antenna device according to claim 1, wherein the first radiator includes a mesh structure.

11. The antenna device according to claim 1, wherein the second radiator includes a mesh structure including electrode lines which intersect each other, and each of the electrode lines has a line width of 2.5 to 25 μm.

12. The antenna device according to claim 1 further comprising a first circuit board electrically connected to the first antenna layer and a second circuit board electrically connected to the second antenna layer.

13. The antenna device according to claim 12, wherein the first circuit board and the second circuit board are disposed on different sides among peripheral portions of the first dielectric layer.

14. An image display device comprising the antenna device according to claim 1.
